(19) United States
(12) Patent Application Publication
(10) Pub. No.: US 2018/0330302 A1
(43) Pub. Date: Nov. 15, 2018

(54) Method for Dynamic Employee Work Assignment

(71) Applicants: Vaughn Peterson, Provo, UT (US); Jacob Christensen, Syracuse, UT (US); David Bean, West Bountiful, UT (US); Hunter Sebresos, Lehi, UT (US); Jon Moody, Highland, UT (US); Lloyd Weffer, Provo, UT (US); Trevor Peterson, West Jordan, UT (US); Thomas Rich, Mesquite, NV (US); Robert Wesson, Riverton, UT (US); Joe Fox, Spanish Fork, UT (US)

(72) Inventors: Vaughn Peterson, Provo, UT (US); Jacob Christensen, Syracuse, UT (US); David Bean, West Bountiful, UT (US); Hunter Sebresos, Lehi, UT (US); Jon Moody, Highland, UT (US); Lloyd Weffer, Provo, UT (US); Trevor Peterson, West Jordan, UT (US); Thomas Rich, Mesquite, NV (US); Robert Wesson, Riverton, UT (US); Joe Fox, Spanish Fork, UT (US)

(21) Appl. No.: 15/593,930

(22) Filed: May 12, 2017

(51) Int. Cl. G06Q 10/06; G06N 3/08; G10L 25/66; G06K 9/00

(52) U.S. Cl. CPC G06Q 10/06398; G06N 3/08; G10L 15/16; G06K 9/00302; G10L 25/66

(57) ABSTRACT

A novel method for managing employees using one or more processors including non-transitory memory programmed to assign job duties to the one or more employees being managed based on correlations between individual employee historical records, out-of-range deviations of non-invasive biometric indicators, indicators of production, and performance trends of the employee(s) being managed. Biometric data is collected and correlated to determine deviations from an established baseline in order to readily identify and assign optimized job duties to an employee or an employee workforce. Poor job related performance by a single employee or plurality of employees may be detected and corrected.

### BACKGROUND

### Field of the Invention

The present invention provides a method of managing a single employee or a plurality of employees by identifying the individual employee and the employee's daily production fluctuations using measurements of biometric indicators, indicators of production, imaged data, speech data, auditory data and obtained, time-stamped and correlated to issue work, job and/or duty assignments.

### BACKGROUND OF THE INVENTION

Employers are confronted with the negative affect of a percentage of the employee workforce having fluctuating production events of poor job performance ranging from a few moments to several days in length. Recognizing and considering the following factors of individual employee value, the spectrum of individual employee talent and the negative contribution of intrinsic fluctuations in the average employee's performance and productivity within the workplace or business environment compounds the challenges of management and an organization's ability to compete. This loss of productivity, loss of sales focus and loss of customer focused awareness such that derive from intrinsically occurring poor performance events negatively affect the employer's annual profits.

### SUMMARY

A novel method for managing employees using one or more processors including non-transitory memory programmed to assign job duties to the one or more employees being managed based on correlations between individual employee historical records, out-of-range deviations of non-invasive biometric indicators, indicators of production, and performance trends of the employee(s) being managed. Biometric data is collected and correlated to determine deviations from an established baseline in order to readily identify and assign optimized job duties to an employee or an employee workforce. Poor job related performance by a single employee or plurality of employees may be detected and corrected.

In one embodiment, a biometric indicator is obtained by detecting body temperature using a wearable device such as a watch, name tag, or by remotely sensing body temperature using machine vision, or infrared cameras. In another embodiment, electronic facial recognition or electronic facial expression detection is used to identify and/or detect a mood or emotional state of an employee. Facial expressions may be recorded electronically and may be analyzed by an Emotion Recognition Application Program Interface (API) such as EmoVu, Affectiva, Emotient, IBM Watson, or Project Oxford by Microsoft. Biometric indicators may be marked with a time stamp and a location of each of the one or more biometrics indicators obtained from the one or more of the employees being managed. A processor and memory may store indicators of production, sales and/or performance into individual employee profiles, determine performance trends and make changes to employee work or job assignments and/or duties. Biometric indicators such as respiration rate, heart rate and blood pressure may be detected by a stand-alone device, wearable device or sensor such as a watch, wristband, necklace or a device similar to those made by Fitbit, Crossmatch or Valencell. Biometric indicators may be stored, compared, and associated with work performance indicators, location, time-of-day, and biometric indicators of other employees within a predetermined region surrounding one or more employees being monitored. Pupil dilation, rate of body movement, body language, posture may be recorded with a camera and analyzed using a body language application program interface (API) such as Bluejeans with results and/or analysis stored in an employee profile. The rate of perspiration may be measured by a wearable or stationary bio-impedance device or calculated by weight or any other method of measurement. A number of toilet visits per day, number of dietary consumption events per day and amount of fluid or fluid intake events per day may be employee self-reported, recorded and associated with an employee profile. An employee productivity base line, related to specific work assignments and locations of the specific work assignments, may be established and associated with employee biometric indicators at the time the work assignments are being performed. Deviations in baseline work performance may be associated with biometric markers of employees performing the work. Deviations in biometric marker baselines may be associated with deviations in baseline work performance of employees. Baseline work performance values may be obtained by averaging two or more work performance values for a given work assignment of a specific employee. values and baseline biometric marker values may be obtained by averaging two or more respective values. Volatile compound detection events will be detected by compound sniffing technologies. The rate of hygienic habits and grooming habits are recorded electronically and stored in an employee profile. The employee speech is analyzed by using Hidden Markov Models, Dynamic Time-warping (DTW) based speech recognition, Neural networks, End-to-End Automatic Speech Recognition, or any other method of speech analysis is recorded and cataloged electronically and associated with an employee profile. The employee profile is retained on file and accumulates data to create a historical record that is then used to track trends and correlations of the employee indicators and the performance indicators, to be used by the processors to assign work duties to the employees being managed. The job duties may be assigned through devices connected to a network selected from the group consisting of a wide area network, a local area network, a cloud based network, and the Internet, or a combination thereof.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows various biometric indicators in accordance with an embodiment of the invention;

FIG. 2 depicts collection of one or more biometric indicators in accordance with an embodiment of the invention;

FIG. 3 shows indicators of production and an association with a time stamp in accordance with an embodiment of the invention;

FIG. 4 shows a flow diagram in accordance with an embodiment of the invention;

FIG. 5 shows a method of work management in accordance with an embodiment of the invention;

FIG. 6 shows a method of work management in accordance with an embodiment of the invention;

FIG. 7 shows a method of work management in accordance with an embodiment of the invention;

FIG. 8 shows a flow diagram in accordance with an embodiment of the invention;

FIG. 9 shows a biometric indicator graph in accordance with an embodiment of the invention; and

FIG. 10 shows a biometric indicator graph in accordance with an embodiment of the invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings.

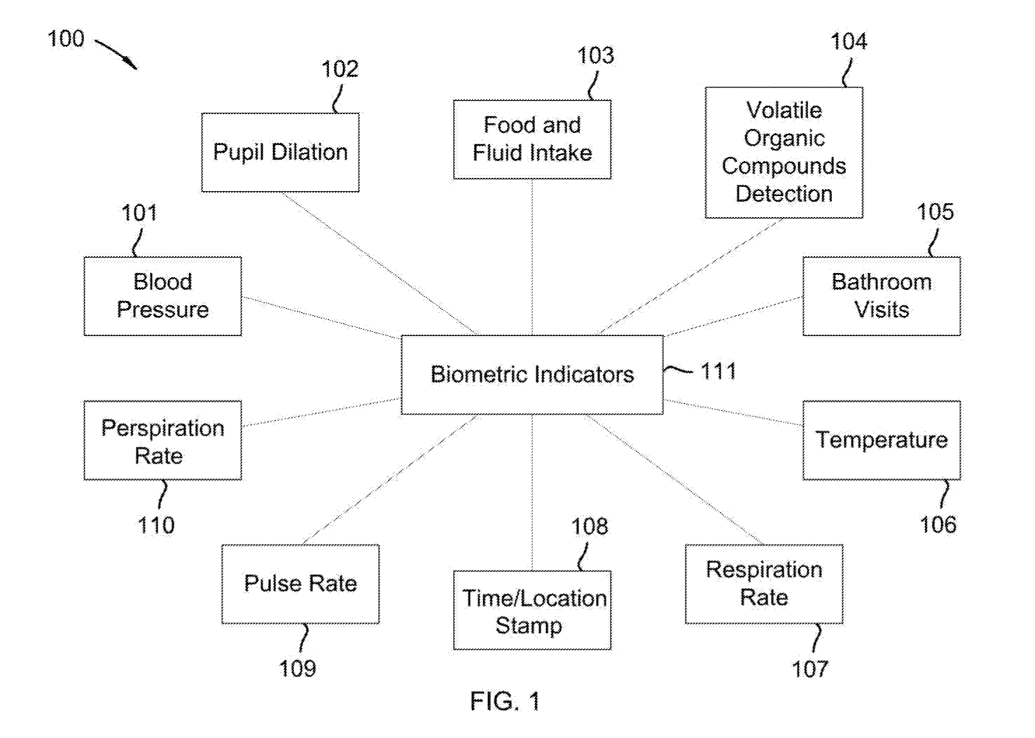

FIG. 1 illustrates, at 100, employee biometric indicators 111 including: blood pressure 101, pupil dilation 102, food and fluid intake 103, volatile organic compound detection 104, bathroom visits 105, body temperature 106, rate of respiration 107, time of day stamp 108, pulse rate 109, and perspiration rate 110. Biometric indicator samples may be obtained by non-invasive sensor observation or by direct input. Biometric indicator sample may be obtained during an initial on-boarding and/or training of an employee. Biometric indicator baseline trends may be established by monitoring an employee under controlled environmental and exercise conditions. Established biometric indicator baselines may be stored and associated with an employee profile. Other biometric indicator samples may be obtained by sensor observation of employees. Sensors for observing may include optical sensors, electromagnetic sensors, mobile devices, cell phones, etc. Internet databases may store and provide access to biometric indicators obtained from sensors in cars, homes, offices, bathrooms, online social media postings, etc. Biometric indicator elements may be time-stamped and location stamped associating the moment and the location the obtained biometric indicator. A time-of-day, location, and/or activity in relation to one or more biometric readings may be used to determine if the one or more biometric readings fall outside of one or more predetermined thresholds about an employee's one or more biometric baselines for that activity, location, and/or time-of-day.

Biometric indicators may include pupil dilation 102, of which may be monitored with machine vision, high-resolution photography/videography, human observation, and/or employee self-reporting. Measured pupil deviations from a predetermined baseline range may be useful in the detection of employee health changes, illicit drug use, concussions, and prescription drug use. Measured pupil dilation changes may include a ratio of one pupil to the other pupil, a single pupil size compared to an established baseline pupil size stored in an employee profile, a pupil size at a specific work location (front door, back door), a pupil size at a specific time-of-day/time-of-year, and/or a pupil size referenced against or correlated to a measured light intensity at the time the pupil size measurement was taken. For example, an employee is in an automobile accident on the way to work and feels fine except for a headache. As the employee enters an entrance at work, a door camera takes a high definition photo or video of the employee's face and a connected computer system determines that the employee's pupil dilation is out of a predetermined baseline range for that specific employee and also determines that a difference in pupil size between each pupil is out of a predetermined baseline range(s) for employee. The employee and/or the employee's supervisor may be notified of the biometric findings and possible causes and/or impaired conditions associated therewith. The employee may be prompted to self-report, by way of an application program, any reasons for the biometric deviation(s). A computer system responsible for employee work assignment may automatically reassign the employee from driving a forklift to light duty solely based on the automatically detected biometric pupil size deviation. The employee's job duties may be assigned and reassigned using devices connected to a network selected from the group consisting of a wide area network, a local area network, a cloud based network, and the Internet, or combinations thereof.

Blood pressures 101 and pulse/heart rates 109 may be taken at a designated time and place or continuously monitored with a portable wearable device. A battery powered, continuously monitoring blood pressure and/or heart/pulse rate device, such as a watch, may report blood pressure changes and/or heart rate changes that fall outside of a predetermined threshold set by a remote system or predetermined thresholds set by a baseline established within the reporting software in the wearable device. Reporting frequency may be dependent upon any established baseline reporting thresholds and in consideration of, and/or in direction of medical professionals, providers of healthcare and/or by direction of employee medical insurance plans. For example, as an employee enters work, a blood pressure heart rate watch device, wore by the employee, reports to a work computer system that the employee's blood pressure and/or heart rate is outside of a predetermined baseline range for that specific employee in relation to a time-of-day, activity, and/or location. The employee and the employee's supervisor may be notified of the biometric findings and possible causes/indications. The employee may be prompted to self-report, by way of an application program, any reasons for the biometric deviation. A computer system responsible for employee work assignment may automatically reassign the employee from driving a forklift to light duty solely based on the automatically detected biometric deviation(s).

Perspiration rate 110 or respiration rate 107 may be measured by a wearable, stationary or moveable bio-impedance device, capacitive sensor, inductive sensor, optical sensor, resistive sensor, or other medically accepted method of perspiration measurement. Measurement frequency thereof may be dependent on a single or any combination of established baselines. Perspiration rate 110 or respiration rate 107 may be taken at a designated time and place or continuously monitored with a portable device/wearable device. A camera may be used to detect visible signs of perspiration, sweat beads, wet spots on clothing, and skin reflectance indicative of perspiration. A camera may be used to detect visible signs of breathing such as moving of an employee's chest. A microphone may be able to detect respiration by breathing noises. A microphone may be located on an employee device such as a cell phone or other personal device. A battery powered, continuously monitoring bioimpedance device, capacitive sensor device, inductive sensor device, optical sensor device, acoustic device, and/or resistive sensor device, in a watch or other worn device, may report perspiration and/or respiration changes and/or heart rate changes that fall outside of a predetermined threshold set by a remote system or predetermined thresholds set by a baseline established within the reporting software in the wearable device. Reporting frequency may be dependent upon any established baseline reporting thresholds and in consideration of, and/or in direction of medical professionals, providers of healthcare and/or by direction of employee medical insurance plans. For example, as an employee enters work, a bioimpedance heart rate watch device, wore by the employee, reports to a work computer system that the employee's perspiration rate is outside of a predetermined baseline range for that specific employee in relation to a time-of-day, activity, and/or location. The employee and the employee's supervisor may be notified of the biometric findings and possible causes. The employee may be prompted to self-report, by way of an application program, any reasons for the biometric deviation. A computer system responsible for employee work assignment may automatically reassign the employee from driving a forklift to light duty solely based on the automatically detected biometric deviation.

Many common products contain the following examples of Volatile Organic Compounds (VOCs) including benzene, alcohol, ethylene glycol, formaldehyde, methylene chloride, tetrachloroethylene, toluene, xylene and 1,3-butadiene whereas inhaling chemical vapors of common products such that comprise cleaning supplies, paints, varnishes, glues, adhesives, permanent markers and indoor furnishings can effect employee health and performance within the workplace and therefore, the atmosphere of the workplace may be monitored for such contaminants using federal agency approved devices, methodologies, scaling and standards. Measurement frequency thereof may be processor decided or dependent on any single or any combination of established baselines. Detection of VOCs may be correlated to employee biometrics indicators and when employee biometric indicators are outside of a predetermined threshold and VOCs are detected in an area around a work environment of the employee, an automatic reassignment of an employee to a new work area may occur. An employee and supervisor may also be notified of the biometric indicator/VOC association.

Employee body temperatures 106 may be monitored by wearable such as watches, necklaces, name tags, or by stationary non-contact devices such as cameras, thermal imagers, infrared cameras, optical detectors, in order to obtain temperature readings of an employee. Employ temperature readings may be taken along with time-of-day and location data and stored in an employee profile. A baseline biometric body temperature with upper and lower threshold limits may be obtained by taking an average temperature of an employee over two or more data points and setting an upper threshold limit by adding one degree Fahrenheit and a lower limit threshold by subtracting one degree Fahrenheit. A unique baseline biometric body temperature may be established for each temperature device within a work environment for each employee. The unique biometric baseline body temperature may be further filtered by time-of-day data, time-of-year data, location data, and ambient temperature data. If a single reading of an employee's body temperature is over or under the baseline reading by one degree or more Fahrenheit, a biometric indicator advisement may be sent to the employee and the employee's supervisor indicating that the employee may be sick. The employee and the employee's supervisor may be notified of the biometric findings and possible causes. The employee may be prompted to self-report, by way of an application program, any reasons for the biometric deviation. A computer system responsible for employee work assignment may automatically reassign the employee from working with a group of employees to independent work solely based on the automatically detected biometric deviation.

Food intake and fluid intake 103 may be self-reported by description, frequency, volume and are useful in identifying nutritional malfunctions and health related problems contributing to poor job performance. Measurement frequency thereof may be dependent on any single or any combination of established baselines.

Bathroom visits can be electronically analyzed and transmitted to an individual employee profile using User Identifying Toilet technologies, such as is described by commonly owned U.S. Pat. No. 9,254,342 which is hereby incorporated by reference for all that it discloses. Additionally, or alternatively, bathroom visits may be self-reported with one of, or any combination of description, frequency, or volume may aid in identifying events that may factor into poor job performance. For example, an employee's bathroom visits are logged and recorded an associated with an employee profile. The historical bathroom data predicts an increase of bathroom visits by a specific employee with a specific reoccurring monthly pattern. During the predicted time period of increased bathroom visits, a computer system responsible for employee work assignments, may automatically reassign the employee to a work area close to a bathroom in order to increase the work efficiency of the employee.

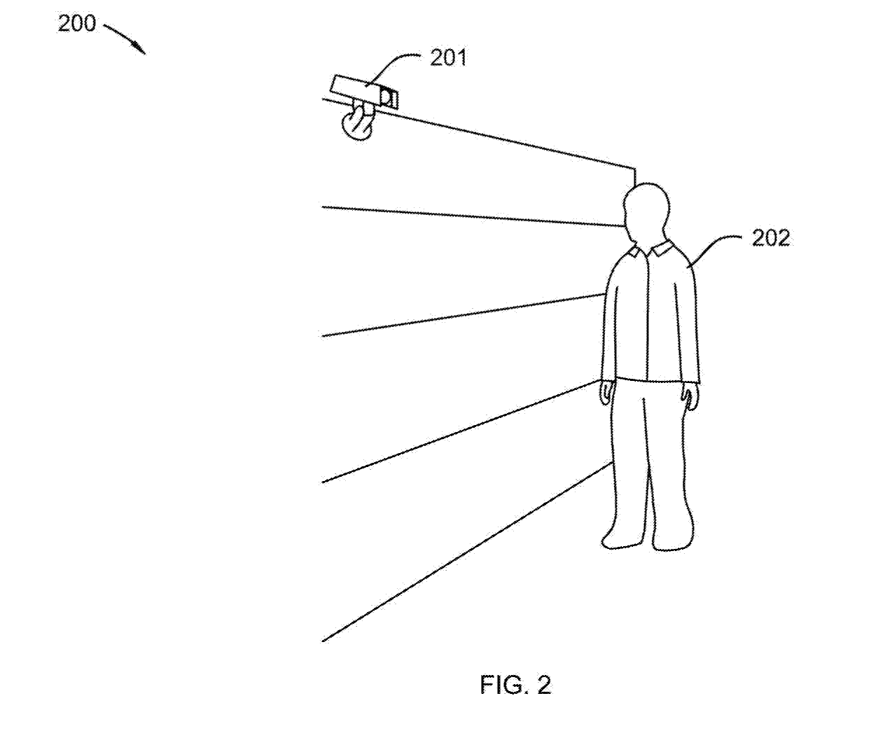

FIG. 2 illustrates, at 200, one or more embodiments of the invention, where a mounted spectrograph or high-definition camera 201 may detect, identify, and/or measuring pupil dilation of an employee 202. In another embodiment of the invention, FIG. 200 may show a mounted high-definition camera 201, mounted spectrograph 201, mounted electronic vision device 201 or mounted combination module thereof 201 actively identifying and measuring a body temperature of an employee 202. In another embodiment of the invention, FIG. 200 demonstrates a customer service associate 202 having their respiration rate measured by a mounted electronic vision module 201 or a mounted high-definition camera 201. In another embodiment of the invention, FIG. 200 may illustrate an employee service representative in the process of having a radial or carotid artery pulse rate measured by a mounted electronic vision module 201 or a mounted high-definition camera 201. In another embodiment of FIG. 200, the image may depict a public library employee being monitored and having their perspiration rate measured by mounted high-definition camera 201, mounted spectrograph 201, mounted electronic vision device 201 or mounted combination module thereof 201. The above stated embodiments along with any intelligible combinations extrapolated from the spirit of the invention pertaining to FIG. 200 may have one or more processors including non-transitory memory programmed to assign job duties, time-stamps and associates a single measurement or any combination thereof with a corresponding single employee profile or plurality of individual corresponding employee profiles to be readily compared with the one or more individual corresponding established biometric baselines by the one or more processors.

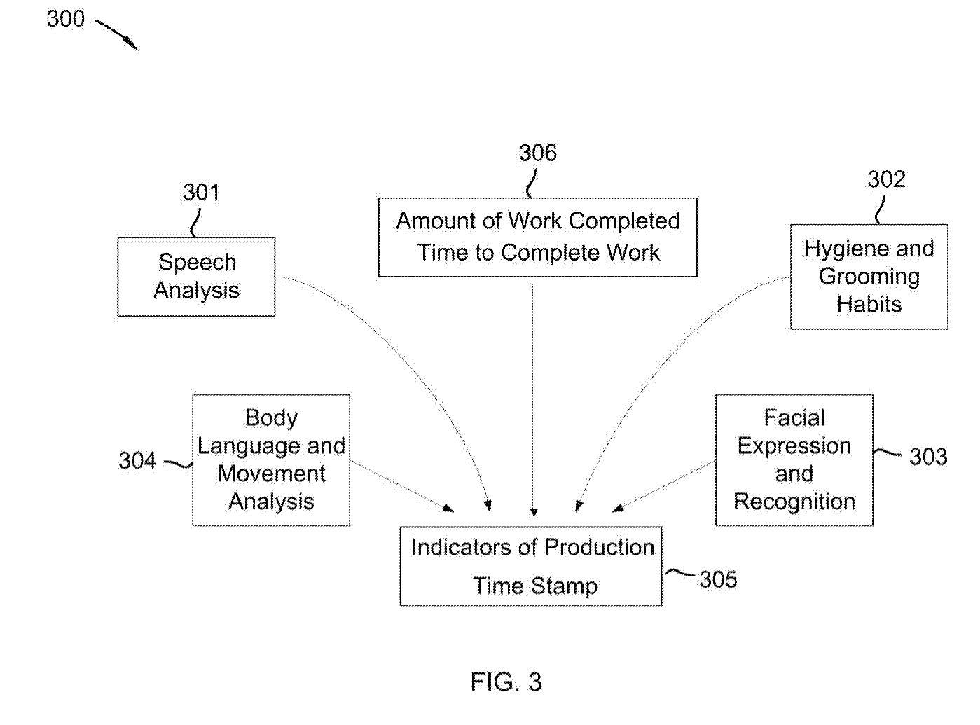

FIG. 3 is an illustration depicting possible components of production indicators 305 that are associated with an employee profile. A time stamp association may occur at a time of recording an individual indicator of production measurement or immediately prior to an association to an employee profile. It is understood that the measurement, time stamp and employee association may occur concurrently or may occur in immediate succession. Employee speech 301 may be electronically captured, transcribed, and analyzed using Hidden Markov Models, Dynamic Time-warping (DTW) based speech recognition, Neural networks, End-to-End Automatic Speech Recognition, or any other method of speech analysis and show an association as one or more elements of an indicator of production. Body language and movement analysis 304 may be recorded and electronically analyzed using a body language application program interface (API) such as Bluejeans and show an association as one or more elements of an indicator of production. Hygiene and grooming habits 302 may be employee self-reported, employee-peer reported, processor reported via an app or a processor and recorded electronically and show an association to one or more elements of an indicator of production. Facial expression and recognition 303 may be recorded electronically and analyzed by an Emotion Recognition Application Program Interface (API) such as EmoVu, Affectiva, Emotient, IBM Watson, Project Oxford by Microsoft or other emotion recognition or facial recognition API and shows an association as one or more elements of an indicator of production. An indicator of production 305, may comprise a measure of an employee work product such as an amount of work completed 306 or an amount of time to complete a task or job 306. In addition to a measure of an employee work product, body language 304 such as smiles, laughs, rate of body movement may be used in combination with an employee work product to determine an indicator of production. For example, if an employee gets his work finished and was happy while working and inspired others while working this may be factored in to a specific indicator or production for the specific employee, time stamped and correlated to biometric indicators of the employee. On the other hand, if an employee gets his work done and is unhappy, this too can be correlated with biometric indicators and associated with an employee profile. Facial expressions 303 and hygiene 302 may be used to determine an employee indicator of production. An indicator of production may measure an amount of work completed and also social impacts on other employees and customers while and after the job is be performed. Customer satisfaction and employee retention may be optimized by dynamically assigning employee responsibilities which take into account a biometric state of the employee.

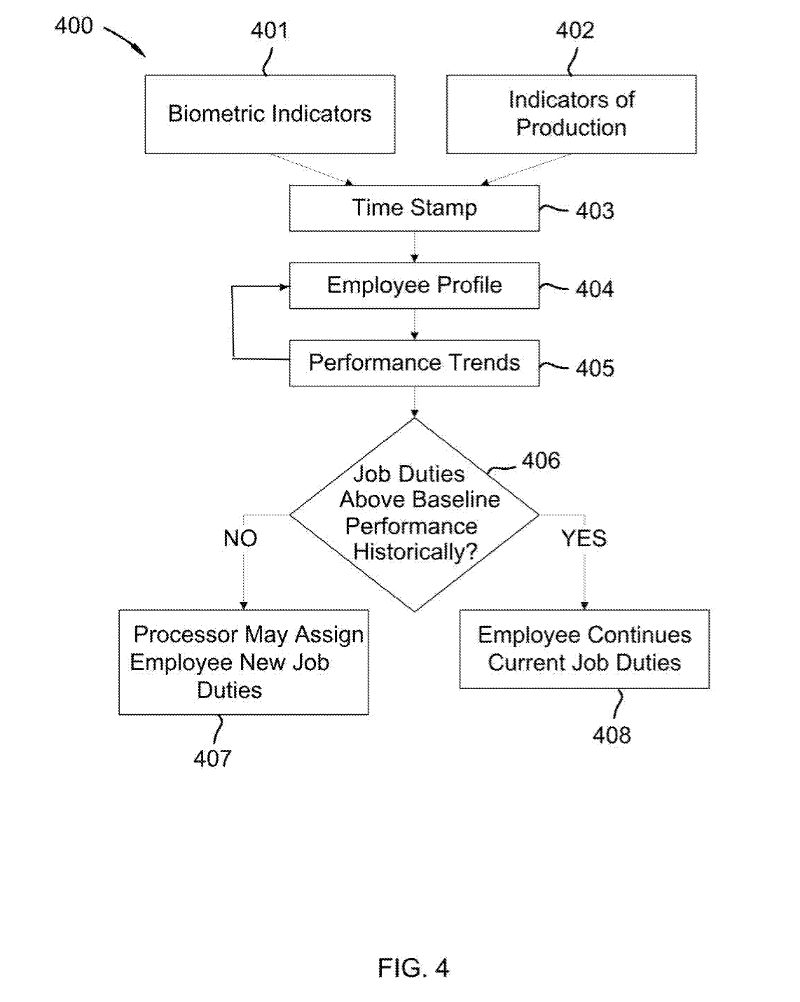

In an embodiment of the invention, FIG. 4 shows a flow chart 400 illustrating work assignment elements that may comprise a processor decision processes of one or more embodiments of the current invention. For each work assignment given to an employee, biometric indicators 401, indicators of production 402, and performance trends 405 may be stored time stamped and associated with an employee work profile. Biometric indicators 401 and indicators of production 402 may be obtained from one or more employees (described earlier), time stamped 403, and associated with an employee profile 404. Employee performance trends 405 may be correlated to employee indicators of production 402 and employee biometric indicators 401. Employee performance trends 405 may be used to determine if an employee is operating within a normal performance range based on historical performance trends, historical production indicators, and historical biometric indictors. Historical performance trends may have an upper bound (highest historical production for the specific employee) and lower bounds (lowest historical production for the employee). Patterns of high performance and low performance may be associated with biometric indicators 401, indicators of production 402, and time-of-day data, time-of-year data, location data, and specific task data. Specific task data may be a type of work assignment the employee performed. Performance trends may be used in conjunction with a current biometric state of an employee to assign an instantaneous work task based on historical data and current biometric data in order to optimize employee work performance. For instance, an employee comes to work with high blood pressure which is detected upon arrival at work. The high blood pressure biometric state is used to filter historical tasks with both high performance and high blood pressure and assigns the employee a task to optimize use of the high blood pressure biometric state of the employee to accomplish the most work. In another embodiment, an employee is working on an assigned task and it is detected that his heart rate is lower than his historical baseline heart rate for the task he is performing and his body movement is slower than normal. A computer system responsible for employee work assignments, may automatically reassign the employee to another work area or suggest the employee take a break and eat some food in order to increase the work efficiency of the employee. A biometric indicator threshold may be a single or a combination of established baseline values correlated with an employee's profile. In another embodiment, an employee arrives at work with a work assignment to work at a cash register. Upon arrival, an infrared camera discovers the employee has a fever of 101 degrees Fahrenheit. A computer system responsible for employee work assignments checks for historical work correlations for this employee and high employee body temperatures. The computer finds, based on historical analysis of employee work trends, that the employee is expected to perform at or above a baseline performance rate if he is assigned to work in the Bakery when he has a fever. The computer then automatically reassigns the employee to work in the bakery instead of a previously assigned cash register.

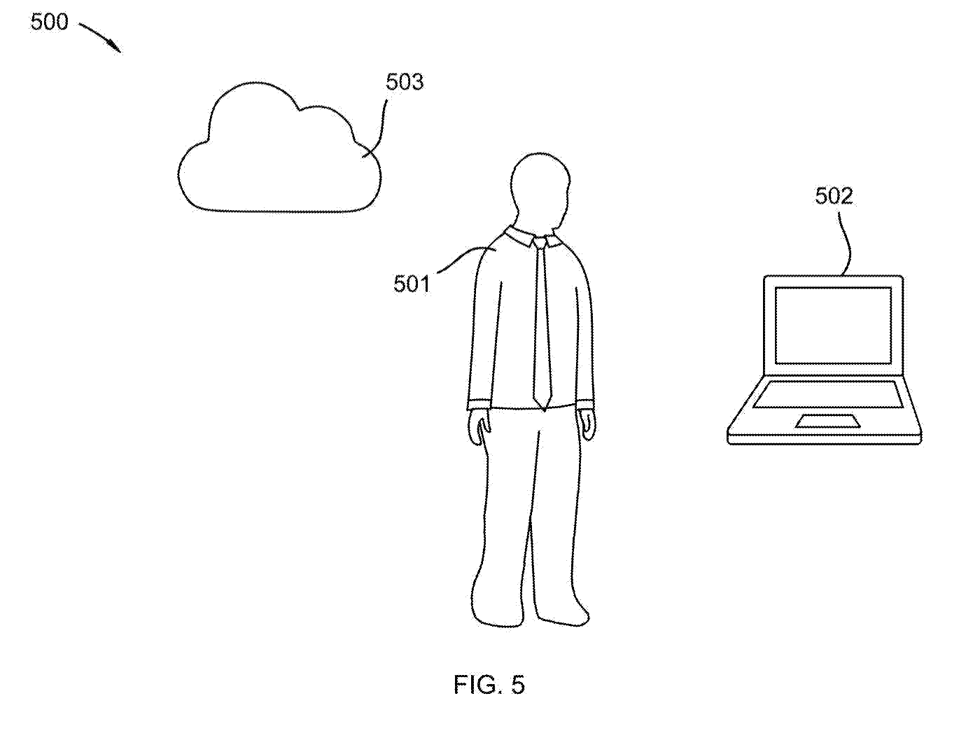

In FIG. 5, shown generally at 500, within the embodiment of the invention, the illustration shows examples of the one or more processors including non-transitory memory programmed to obtain, store and create biometric indicators, indicators of production, establish baselines from historical records, assign job duties to the one or more employees being managed based on the historical record of the one or more biometric indicators correlated to the one or more indicators of production in forms that may include a cloud based server 503, an employee 501, electronic storage 502, 503 in the form of database servers, computers, laptops, notebooks, tablets, cell phones, and personal devices 502 503, for example. Devices 502, 503 may form a wide area network, a local area network, or a cloud based network. The wide area network may be connected to one or more devices 502, 503 over the Internet. A cloud-based network may also be connected over the Internet. Devices 502, 502 may be a combination of wired and wireless devices. Employee 501 may be connected to devices 502, 503 by way of a cellular phone and/or sensors for obtaining biometric indicators discussed previously. A cellular phone of employee 501 may provide one more invasive or non-invasive biometric indicators or employee self-reporting features to devices 502 and/or 503. The job duties may be assigned through devices connected to a network selected from the group consisting of a wide area network, a local area network, a cloud based network, and the Internet, or a combination thereof. Devices 502 and/or 503 may be used to assign an employee work assignment to employee 501 as employee 501 arrives at work based in part on historical employee biometric and/or employee production data stored in an employee profile.

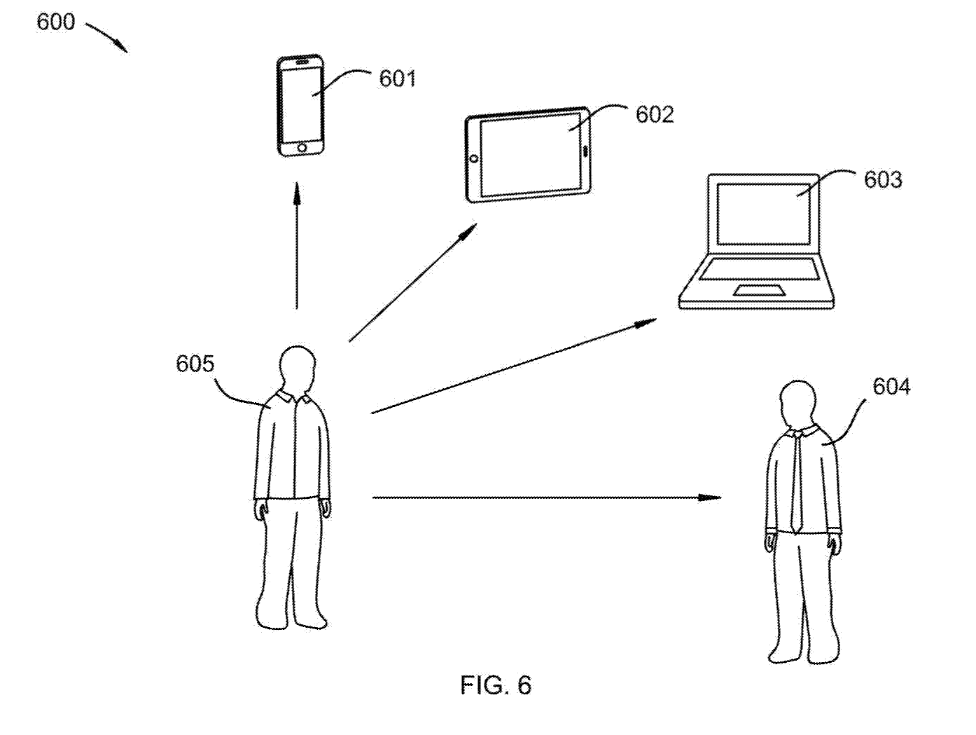

FIG. 6, illustrates at 600 various methods an employee may self-report biometric indicators or indicators of production to a managing processor or designee by a web application interface using a mobile phone 601, tablet 602, notebook 603, laptop 603, computer 603, or verbally communicated to a managing processor or designee 604 whereby whom will electronically associate the biometric indicators and/or the indicators of production to the appropriate employee profile.

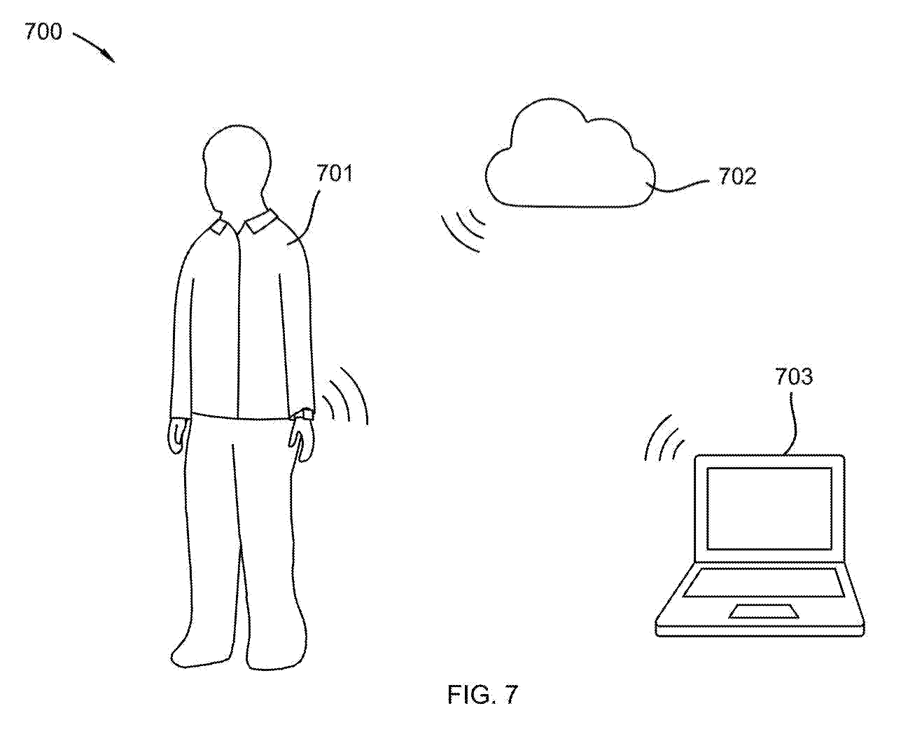

FIG. 7, illustrates at 700 how in one embodiment of the invention, a device may be worn on the wrist 701 and monitors, transmits in real-time biometric indicators or indicators of production that may include, pulse rate, temperature, perspiration rate, respiration rate, bathroom visits, speech analysis, body movement analysis and transmits data in real time to a cloud-based processor 702 or centrally located computer processor 703.

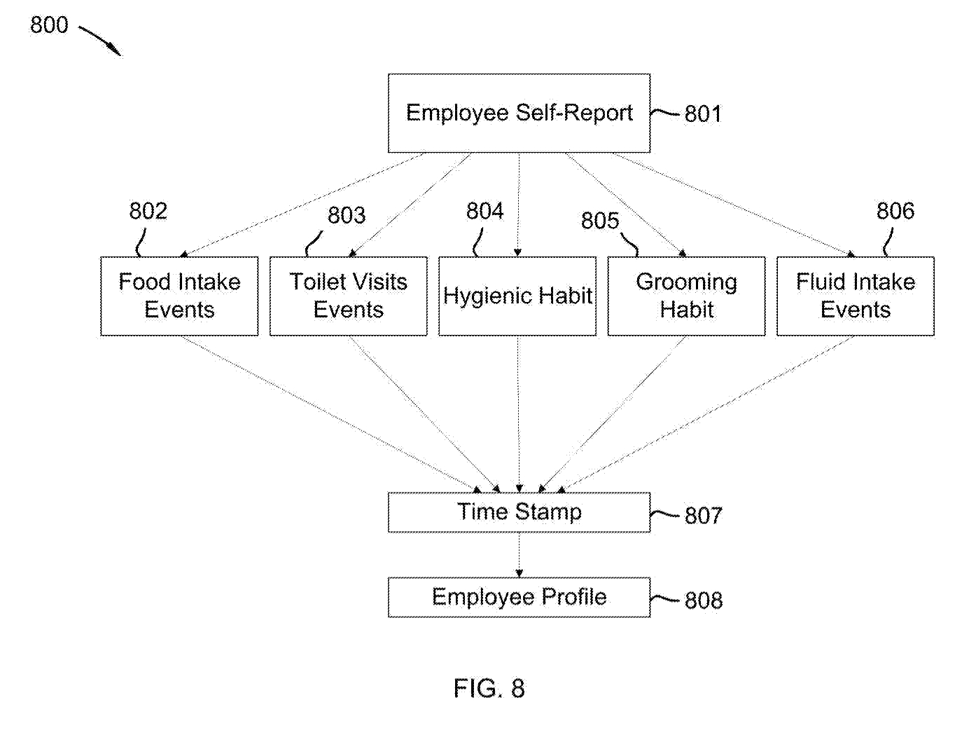

FIG. 8, shown at 800, is a diagram that demonstrates an embodiment of the invention showing the process of an employee self-reporting 801 various biometric indicators and indicators of production. The self-reporting employee 801 may report food intake events 802, toilet events 803, hygienic habits 804, grooming habits 805, fluid intake events 806 as they occur. The events and habits are then time stamped and associated with an employee profile and the data is then analyzed by a work assignment computer.

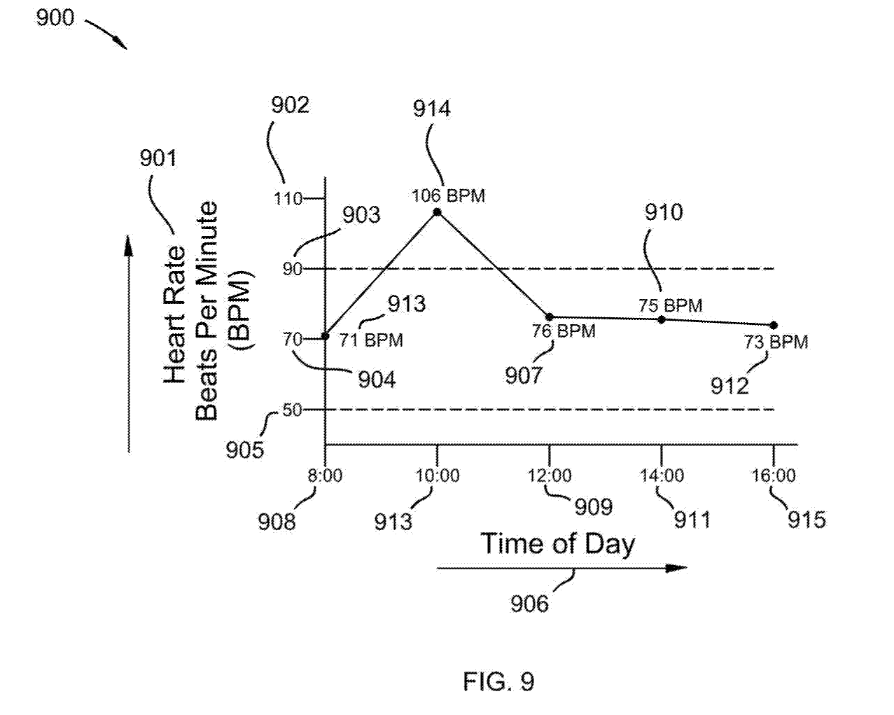

FIG. 9, shows at 900, a time of day 906 graph that also presents an example of the biometric indicator of the pulse rate 901 and may demonstrate tracking the pulse rate every two hours starting at 8 a.m. 908 with the corresponding reading of 71 beats per minute (bpm) 913, at 10 a.m. 909 reaching 106 bpm 914 that may exceed an established baseline of 25% and the processor being alerted to induce intervening action or a change of job duties. After intervening measures, the graph indicates the employee biometric indicators returning to a normal state specific to the baseline of the biometric indicator of employee profile with another measurement of 76 bpm 907 at 12:00 909, another measurement of 75 bpm 910 at 14:00 907 912, a last measurement of 73 bpm 912 at 16:00 915.

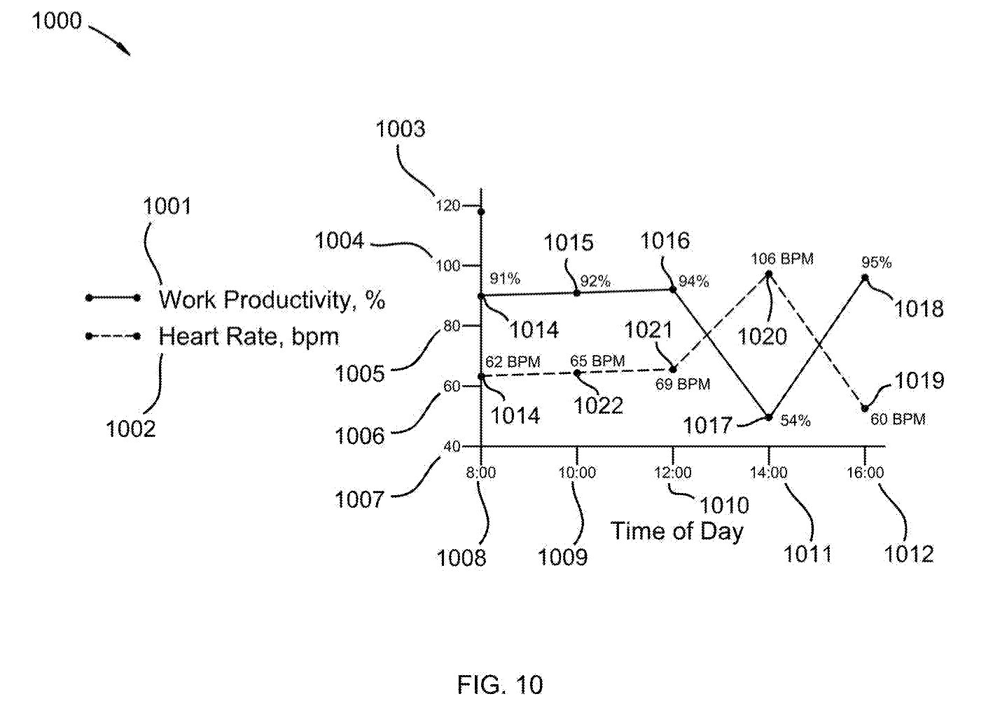

FIG. 10, shows at 1000, a graph representing a percentage of work productivity (solid line) 1001, the percentage of which may be embodied on the Y axis, heart rate in beats per minute (bpm) (segmented line) 1002 the number of which may also be embodied on the Y axis, and time of day 1013 the representation of which may be embodied on the X axis, of which, is overall indicative of correlations between biometric indicators and work productivity. At 08:00 1008, the employee has a measurement of 62 bpm 1023, at 10:00 1009 a measurement of 65 bpm 1022 was recorded, at 12:00 1010 a measurement of 69 bpm 1021 was recorded, at 14:00 1011 a measurement of 106 1020 was recorded, productivity axis indicates a corresponding loss and the processor is alerted to take intervening action, biometric indicator normalizes at 16:00 1012 with a measurement of 61 bpm 1019 after the intervening action is taken.

The systems and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of managing employees comprising:
one or more processors including non-transitory memory programmed to:
obtain one or more biometric indicators of one or more of the employees being managed;
store the one or more biometric indicators with a time stamp and a location of each of the one or more biometrics indicators obtained from the one or more of the employees being managed;
obtain one or more indicators of production of the one or more employees being managed;
store the one or more indicators of production with a time stamp and a location of each of the one or more indicators of production obtained from the one or more of the employees being managed;
create a historical record associating the stored one or more biometric indicators with the stored one or more indicators of production for each of the one or more employees being managed;
determine performance trends from the historical records for each of the one or more employees being managed; and
assign job duties to the one or more employees being managed based on the historical records of the one or more biometric indicators correlated to the one or more indicators of production and the performance trends.

2. The method of claim 1, wherein the biometric indicators include one or more of heart rate, body temperature, rate/speed of motion, body language analysis, posture analysis, facial recognition, expression recognition, rate of speech, rate of respiration, rate of perspiration, number of toilet visits per day, number of dietary consumption events per day, number of fluid intake events per day, pupil dilation, volatile compound detection, or a combination thereof.

3. The method of claim 2, wherein the heart rate includes a resting heart rate and a working heart rate.

4. The method of claim 3, wherein the heart rate includes averaged measurements recorded periodically throughout the employee's daily work routine and classified according to the employee's daily activities.

5. The method of claim 2, wherein the employee temperature is taken by thermal imagery.

6. The method of claim 2, wherein speech is recorded electronically and stored in an employee profile.

7. The method of claim 2, wherein the rate of respiration is recorded electronically and associated an employee profile.

8. The method of claim 2, wherein the number of food intake events are employee self-reported via an app or a processor, recorded electronically and associated with an employee profile.

9. The method of claim 2, wherein the number of fluid intake events is employee self-reported via an app or a processor, recorded electronically and associated with an employee profile.

10. The method of claim 1, further comprising obtaining and storing product sale records of individual product items including a time stamp and a location stamp of the product sales.

11. The method of claim 2, wherein a measurement of pupil dilation is recorded electronically along with a light intensity and/or eye position and associated with an employee profile.

12. The method of claim 2, wherein the rate of perspiration is recorded electronically and associated with an employee profile.

13. The method of claim 2, wherein the rate of toilet visits is measured, transmitted and associated with an employee profile by a user identifying toilet or employee self-reported via a software application program and recorded electronically and associated with an employee profile.

14. The method of claim 2 further comprising recording and associating with an employee profile, employee hygienic and/or grooming habits by one or more of: self-reporting or peer reporting.

15. The method of claim 2, wherein illness or disease is detected by one or more of: heart rate, temperature, rate of motion, body language, posture analysis, facial recognition, expression recognition, rate of speech, rate of respiration, rate of perspiration, number of toilet visits per day, number of dietary consumption events per day, number of fluid intake events per day, pupil dilation, or volatile compound detection.

16. The method of claim 2, wherein the body language and posture are recorded and electronically analyzed using a body language application program interface (API) and associated with an employee profile.

17. The method of claim 6, wherein the speech is analyzed by using one or more of: hidden markov models, dynamic time-warping (DTW), neural networks, or an end-to-end speech recognition system.

18. The method of claim 12, wherein the rate of perspiration is measured by a bio-impedance device.

19. The method of claim 2, wherein the facial expressions are recorded electronically and are analyzed by an emotion recognition application program interface (API) and associated with an employee profile.

20. The method of claim 1, wherein the job duties are assigned or reassigned through devices connected to a network selected from the group consisting of a wide area network, a local area network, a cloud based network, and the Internet, or a combination thereof.
